(19) United States
(12) Patent Application Publication
(10) Pub. No.: US 2014/0051437 A1
(43) Pub. Date: Feb. 20, 2014

(54) PLMN SPECIFIC IMPLICIT REJECT FEATURE FOR CONTROLLING MOBILE STATION SERVICE ESTABLISHMENT

(71) Applicant: Telefonaktiebolaget L M Ericsson (PUBL), Stockholm (SE)

(72) Inventors: John Walter Diachina, Garner, NC (US); Paul Schliwa-Bertling, Ljungsbro (SE); Anders Molander, Linkoping (SE); Bo Ehrenholm, Linkoping (SE)

(73) Assignee: Telefonaktiebolaget L M Ericsson (PUBL), Stockholm (SE)

(21) Appl. No.: 13/909,584

(22) Filed: Jun. 4, 2013

Related U.S. Application Data
(60) Provisional application No. 61/684,411, filed on Aug. 17, 2012.

(51) Int. Cl. H04W 48/06

(52) U.S. Cl. CPC H04W 48/06
USPC 455/434

(57) ABSTRACT

A method is provided by a network node for restricting access attempts by a plurality of mobile stations (MSs). The network node supports a Multi-Operator Core Network (MOCN) having a plurality of Public Land Mobile Networks (PLMNs). The method includes determining that an overload condition is occurring. Responsive to determining that the overload condition is occurring, an Implicit Reject indication is communicated within one or more Access Grant Channel (AGCH) messages or Paging Channel (PCH) messages to the MSs identifying that an Implicit Reject feature is active to restrict access attempts to the network node. A broadcast message is communicated to the MSs containing information identifying at least one of the PLMNs to which the Implicit Reject feature applies. Any of the MSs registered with the at least one of the PLMNs identified by the information can restrict their access attempts to the network node. A corresponding method by a MS and corresponding network nodes and MSs are provided.

### RELATED APPLICATIONS

The present application claims the benefit of priority from U.S. Provisional Application No. 61/684,411 entitled “PLMN Specific Implicit Reject Mode” filed Aug. 17, 2012, the disclosure of which is hereby incorporated herein in its entirety by reference.

### TECHNICAL FIELD

The present disclosure relates to radio access networks and, more particularly, to controlling implicit reject mode of radio access systems.

### BACKGROUND

With the introduction of the FULL-Multi-Operator Core Network (FULL-MOCN) feature a common radio access network node (RAN, e.g. a BSS) will be shared by multiple Mobile Switching Centres (MSCs) and/or Serving GPRS Support Nodes (SGSNs), where each MSC and/or SGSN is associated with a different Public Land Mobile Network (PLMN) identified using a unique PLMN ID value.

If a network node (e.g., GSM EDGE Radio Access Network (GERAN) node) shared between multiple PLMNs (e.g. a BSS) experiences loading issues then the network node can use an Implicit Reject (IR) feature to control (e.g., prevent or restrict) access attempts by Mobile Stations (MS) to the network node (e.g., the BSS).

The IR feature (legacy) will control all MSs that are configured for Low Access Priority equally regardless of their registered PLMN. During such loading issues, the network node may also use Extended Access Barring (EAB) to prevent or restrict MSs from making system access attempts to the network node. The same EAB mask can be used for each of the sharing PLMNs since the network node is shared and the EAB should therefore be applied equally for all supported PLMNs.

However, if a non-shared node (e.g. an SGSN) corresponding to one of the sharing PLMNs experiences loading problems then the IR feature should not be used to throttle radio interface signalling (system access attempts) contributing to that loading problem, for one or more of the following reasons:

1) Using the IR feature would unfairly throttle system access attempts from MSs not registered for the PLMN associated with the problematic non-shared network node;

2) Not using the IR feature in this scenario would limit the GERAN to only using the PLMN specific EAB mask based barring on a PLMN specific basis since it is a PLMN specific non-shared network node that is problematic;

3) Enabling a PLMN specific EAB mask can take more than 30 seconds to fully affect system access control on the MS, because the MS nominally re-reads system information once every 30 seconds to acquire the EAB mask specific to its registered PLMN;

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

### SUMMARY

To address the foregoing problems identified in the prior art, the Detailed Description presented hereinafter will describe several systems and methods directed to more precisely controlling access attempts for mobile stations subject to the legacy Implicit Reject feature.

One embodiment is directed to a method in a network node for restrictng access attempts by a plurality of mobile stations (MSs). The network node supports a Multi-Operator Core Network (MOCN) having a plurality of Public Land Mobile Networks (PLMNs). The method includes determining that an overload condition is occurring. Responsive to determining that the overload condition is occurring, an Implicit Reject indication is communicated within one or more Access Grant Channel (AGCH) messages or Paging Channel (PCH) messages to the MSs identifying that an Implicit Reject feature is active to restrict access attempts to the network node. A broadcast message is also communicated to the MSs upon determining to communicate an Implicit Reject indication and contains information identifying at least one of the PLMNs to which the Implicit Reject feature applies. Any of the MSs registered with the at least one of the PLMNs identified by the information can restrict their access attempts to the network node.

Another embodiment is directed to a corresponding method in a MS for restricting access attempts to a network node supporting MOCN having a plurality of PLMNs. The method includes receiving an AGCH or PCH message from the network node. A determination is made that the AGCH or PCH message contains an Implicit Reject indication identifying that an Implicit Reject feature is active to restrict access attempts to the network node. A broadcast message is received. A further determination is made that the broadcast message contains information identifying at least one of the PLMNs to which the Implicit Reject feature applies. A further determination is made that the registered PLMN of the MS matches at least one of the PLMNs identified by the information contained in the broadcast message. Access attempts to the network node are restricted in response to the determination that the registered PLMN of the MS matches at least one of the PLMNs identified by the information contained in the broadcast message.

A potential benefit of these or other embodiments is that a PLMN Specific Implicit Reject (IR) feature is provided that can provide a much more real time (faster) mechanism for throttling system access attempts for a MS registered for a specific PLMN. This faster throttling mechanism may be beneficial or essential for a problematic network node (non-shared and therefore associated with a specific PLMN) to manage and recover from an overload condition triggered, at least in part, by an excessive number of its corresponding MSs (i.e. registered for that PLMN) attempting service establishment in a limited time period.

Another embodiment is directed to a network node that restricts access attempts by MSs. The network node supports a MOCN having a plurality of PLMNs. The network node includes at least one processor and at least one memory coupled to the at least one processor. The at least one memory includes computer readable program code that when executed by the at least one processor causes the at least one processor to perform operations that include determining that an overload condition is occurring and, if so, communicating an Implicit Reject indication within one or more AGCH messages or PCH messages to the MSs identifying that an Implicit Reject feature is active to restrict access attempts to the network node. Responsive to communicating the Implicit Reject indication, a broadcast message is also communicated to the MSs containing information identifying at least one of the PLMNs to which the Implicit Reject feature applies. Any of the MSs registered with the at least one of the PLMNs identified by the information can restrict their access attempts to the network node.

Another embodiment is directed to a MS that accesses a network node supporting a MOCN having a plurality of PLMNs. The MS includes at least one processor and at least one memory coupled to the at least one processor. The at least one memory includes computer readable program code that when executed by the at least one processor causes the at least one processor to perform operations that include receiving an AGCH or PCH message from the network node. A determination is made that the AGCH or PCH message contains an Implicit Reject indication identifying that an Implicit Reject feature is active to restrict access attempts to the network node. A broadcast message is received. A further determination is made that the broadcast message contains information identifying at least one of the PLMNs to which the Implicit Reject feature applies. A determination is made that the registered PLMN of the MS matches at least one of the PLMNs identified by the information contained in the broadcast message. Access attempts to the network node are restricted in response to the determination that the registered PLMN of the MS matches at least one of the PLMNs identified by the information contained in the broadcast message.

Other methods, network nodes, and mobile stations according to embodiments of the invention will be or become apparent to one with skill in the art upon review of the following drawings and detailed description. It is intended that all such additional methods, network nodes, and mobile stations be included within this description, be within the scope of the present invention, and be protected by the accompanying claims. Moreover, it is intended that all embodiments disclosed herein can be implemented separately or combined in any way and/or combination.

### BRIEF DESCRIPTION OF THE DRAWINGS

Aspects of the present disclosure are illustrated by way of example and are not limited by the accompanying drawings. In the drawings:

FIG. 1 is a block diagram of a Multi-Operator Core Network that is configured to operate according to some embodiments;

FIG. 2 is a diagram that illustrates the content, including system information (SI), of TDMA frames transmitted via a Broad Control Channel Extended according to some embodiments;

FIG. 3 illustrates a diagram of operations, methods and associated message flows for controlling access attempts by a MS 100 to a network node (e.g., BSS) 122 of the Multi-Operator Core Network of FIG. 1 according to some embodiments;

FIG. 4 is a block diagram of an example network node (e.g., BSS) 122 of FIGS. 1-3 that is configured according to some embodiments; and

FIG. 5 is a block diagram of an example MS 100 of FIGS. 1-3 that is configured according to some embodiments.

### DETAILED DESCRIPTION

Embodiments of the present disclosure will be described more fully hereinafter with reference to the accompanying drawings. Other embodiments may take many different forms and should not be construed as limited to the embodiments set forth herein. Like numbers refer to like elements throughout.

One or more of the foregoing problems may be overcome by various embodiments disclosed herein. Use of an EAB mask to control system access requests from MSs may not be fast enough, from the perspective of an overloaded (problematic) network node seeking immediate load relief, to effectively throttle the radio interface signalling contributing to the overloaded (problematic) network node. In view of this and other problems, various embodiments disclosed herein provide methods, MSs, network nodes, and systems that allow much more “real time” (i.e., faster compared to using the legacy PLMN specific EAB mask access control mechanism) IR feature that operates on a PLMN specific basis referred to herein as a PLMN Specific IR feature. In addition to the situation where a specific non-shared network node is experiencing loading problems, there can also occur a situation where multiple non-shared network nodes associated with the same PLMN are cumulatively experiencing excessive overload and would therefore benefit from much more “real time” PLMN Specific IR feature becoming operational for that specific PLMN.

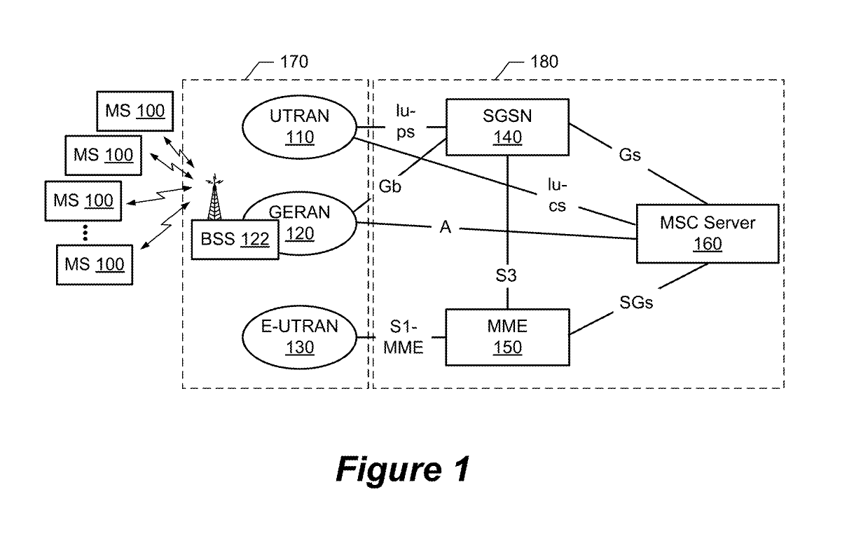

These operations and methods for the PLMN Specific IR feature disclosed herein can be provided as an extension to the existing Third Generation Partnership Project (3GPP) processes that enable and provide an IR feature to mitigate overload conditions occurring on a GERAN radio access network (in a PLMN agnostic manner). Accordingly, some embodiments are explained herein in the context of an example 3GPP Multi-Operator Core Network (MOCN) 170 shown in FIG. 1. Although various embodiments are disclosed in the context of the network of FIG. 1, the invention is not limited thereto.

The MOCN 170 comprises a plurality, typically thousands, of MSs 100 (also known as user equipment nodes, wireless terminals, or cellular phones) that communicate through radio access communication links with a UMTS Terrestrial Radio Access Network (UTRAN) 110, a GERAN 120, and/or an Evolved-UTRAN (E-UTRAN) 130.

The UTRAN 110 and GERAN 120 can include a base station subsystem (BSS) 122 that includes a radio network controller (RNC) or base station controller (BSC) nodes that control communications through a radio transceiver base station providing radio access communication links to MSs 100 that are within their respective communication service cells. The E-UTRAN 130 can include radio base station nodes (eNodeBs) that can provide the combined functionality of the RNC/BSC nodes of the UTRAN 110/GERAN 120.

A plurality of SGSNs 140 (one of which is shown in FIG. 1) are responsible for the delivery of data packets from and to the MSs 100 within their geographical service area. Their tasks can include packet routing and transfer, mobility management (attach/detach and location management), logical link management, and authentication functions. The SGSNs 140 control communications connections between MSs 100 and one or more packet-based networks, and may perform other functions such as mobility management of MSs 100. Mobility Management Entities (MMEs) 150 (one of which is shown in FIG. 1) and the SGSNs 140 provide control plane functionality to enable mobility of MSs 100 between the UTRAN 110, the GERAN 120, and the E-UTRAN 130 via the S3 interface between the MMEs 150 and the SGSNs 140.

The MMEs 150 route and forward signalling packets for the E-UTRAN 130, and are responsible for EPS Connection Management (ECM) idle mode MS 100 tracking and paging procedures, and are involved in connection bearer (Packet Data Network (PDN) connection) activation/deactivation processes, for choosing a Serving Gateway (SGW) for a MS 100 at the initial attachment and at time of handover. A Mobile Switching Centre (MSC) server 160 controls network switching required for CS domain operation.

Because the MOCN 170 supports multiple operators, a common radio access network node (RAN, e.g. the BSS 122) will be shared by multiple of the MSC servers 160, the SGSNs 140, and/or the MMEs 150, where each of the MSC servers 160, the SGSNs 140, and/or the MMEs 150 can be associated with a different Public Land Mobile Network (PLMN). The PLMNs can each be identified using a unique PLMN ID value.

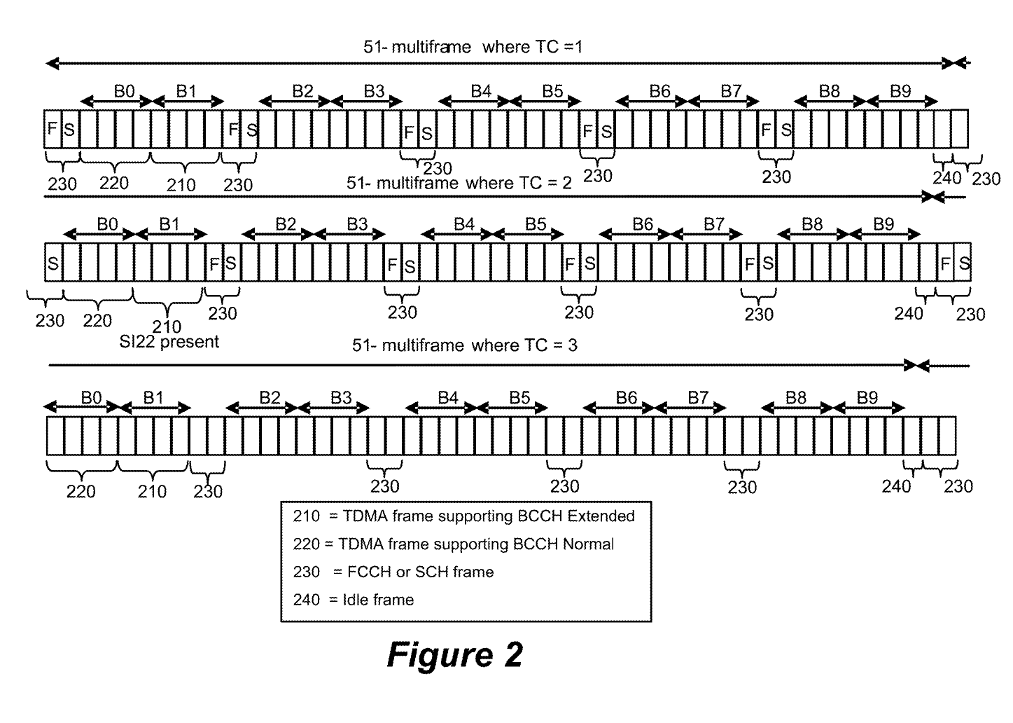

In accordance with some embodiments disclosed herein, a MS 100 that is configured for Low Access Priority (LAP) and that supports shared network operation, responds to detecting that the IR feature is enabled (e.g., according to existing 3GPP processes), by taking the further step of reading System Information 22 (SI22) message (or possibly another SI that occurs frequently and that can support the inclusion of a new 5 bit Implicit Reject bitmap), which is broadcast by a network node (e.g., BSS 122) in a serving cell of the MS 100, to acquire the current Implicit Reject bitmap. Assuming SI22 is used for this purpose then such a MS 100 would look for the next available instance of SI22 sent by the network node (e.g., BSS 122) as part of System Information as shown in Table 1 (below) and in B1 of FIG. 2 for the 51-multiframe where TC=2.

Embodiments of network nodes, MSs, systems, and methods described herein can thereby provide a PLMN Specific Implicit Reject (IR) feature, which can provide a much more real time (faster) mechanism for throttling (controlling) system access attempts for a MS registered for a specific PLMN (i.e. compared to relying on the legacy EAB mask based mechanism which can take up to or more than 30 seconds to fully kick in). This faster throttling mechanism may be beneficial or essential for a problematic network node (non-shared and therefore associated with a specific PLMN) to manage and recover from an overload condition triggered, at least in part, by an excessive number of its corresponding MSs (i.e. registered for that PLMN) attempting service establishment in a limited time period. Some embodiments of the PLMN Specific Implicit Reject feature described herein also allow for multiple distinct non-shared network nodes to experience this faster throttling mechanism at the same time (i.e. the Implicit Reject bitmap can indicate that MSs associated with multiple PLMNs are subject to the IR feature).

Table 1 (below) shows that radio blocks containing SI22 are transmitted by the BSS every fourth (4^{th}) 5-multiframe (or once every 4×235.4 ms=942 ms). In some embodiments, information identifying at least one of the PLMNs to which an Implicit Reject feature applies can be communicated to MSs within SI22 messages, such as within each SI22 message occurring, in the Broadcast Control Channel (BCCH) Extended. In the example embodiment of Table 1, the specific 51-multiframes, used to communicate the information identifying at least one of the PLMNs to which an Implicit Reject feature applies with SI22 messages, are those for which the Transmission Conditions (TCs) equal to 2 and 6. Note that TC=((FN DIV 51) mod (8) where FN is the TDMA frame number.

TABLE 1
SI22 Supported on BCCH Extended

| Instance of | Block 0 Content | | | | | | | |
|---|---|---|---|---|---|---|---|---|
| 51-multi-frame | TC = 0 | TC = 1 | TC = 2 | TC = 3 | TC = 4 | TC = 5 | TC = 6 | TC = 7 |
| 0-7 | SI 13 | FREE | SI22 | SI 8 | FREE | SI2quater | SI22 | SI 7 |
| 8-15 | SI 13 | FREE | SI22 | SI 8 | FREE | FREE | SI22 | SI 7 |
| 16-23 | SI 13 | FREE | SI22 | SI 8 | FREE | SI2quater | SI22 | SI 7 |
| 24-31 | SI 13 | FREE | SI22 | SI 8 | FREE | FREE | SI22 | SI 7 |
| 32-39 | SI 13 | FREE | SI22 | SI 8 | FREE | SI2quater | SI22 | SI 7 |
| 40-47 | SI 13 | FREE | SI22 | SI 8 | FREE | FREE | SI22 | SI 7 |
| 48-55 | SI 13 | FREE | SI22 | SI 8 | FREE | SI2quater | SI22 | SI 7 |
| 56-63 | SI 13 | FREE | SI22 | SI 8 | FREE | FREE | SI22 | SI 7 |
| . . . | . . . | . . . | . . . | . . . | . . . | . . . | . . . | . . . |

FIG. 2 is a diagram that illustrates the content, including SI messages, of TDMA frames transmitted via a BCCH Extended according to some embodiments. In accordance with some embodiments disclosed herein, information identifying at least one of the PLMNs to which an IR feature applies is transmitted within a block of four Time Division Multiple Access (TDMA) frames (210) of a 51-multiframe BCCH Extended occurring once within a defined number (e.g., occurring every fourth TC) of consecutive 51-multiframes. In the non-limiting example embodiment of FIG. 2, four TDMA frames within a 51-multiframe for which TC=2 are used by the BSS 122 (network node) to transmit an SI22 message instance, which contains the information identifying at least one of the PLMNs, using BCCH Extended (i.e. using the 2^{nd} radio block designated as B1 within a 51-multiframe for which TC=2). Another four TCs later (i.e., TC=6), four TDMA frames within a 51-multiframe are used by the BSS 122 (network node) to transmit an SI22 message instance which contains the information identifying at least one of the PLMNs to which the IR feature applies.

Accordingly, the BSS 122 (network node) can dynamically respond to an overload condition arising with one or more network nodes associated with a PLMN by updating the information that is sent in repeatedly occurring SI22 messages to indicate that a IR features applies only to MSs (100) that are registered with the PLMN indicated by the SI22 messages. Similarly, the BSS 122 (network node) can dynamically respond to an overload condition ceasing to exist with the one or more network nodes associated with the PLMN by updating the information that is sent in repeatedly occurring SI22 messages to no longer indicate that the IR features applies to MSs (100) that are registered with the PLMN.

The MS 100 configured for LAP that supports shared network operation will, upon attempting a system access for a given domain (i.e. Packet Switched (PS) or Circuit Switched (CS)) and detecting that the IR feature is active for that domain, wait until it reads the next radio block B1 containing an SI22 message instance to determine if its registered PLMN is subject to the implicit reject. If so, the MS 100 can respond by restricting its access attempts to the network node.

In this manner, methods, MSs, network nodes, and systems are provided that allow much more “real time” (i.e., faster) IR feature that operates on a PLMN specific basis compared to using the legacy PLMN specific EAB mask access control mechanism.

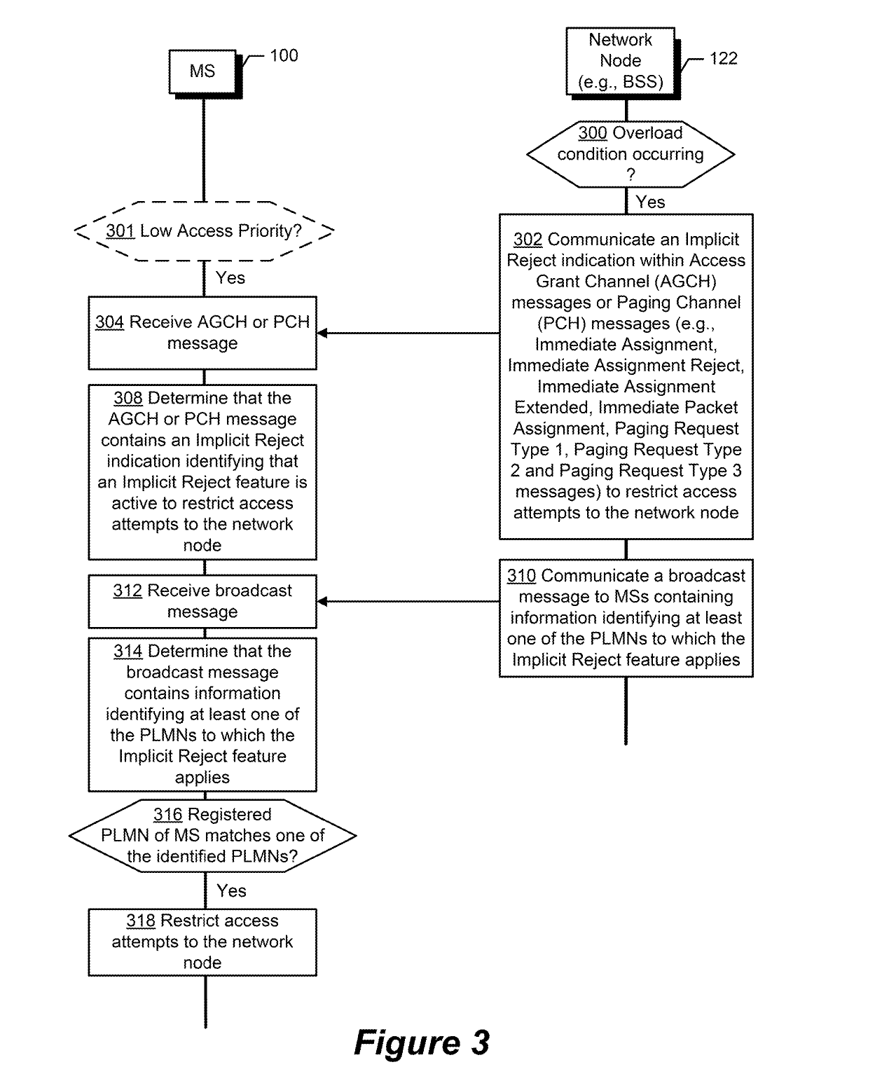

FIG. 3 illustrates a diagram of operations, methods and associated message flows for controlling access attempts by a MS 100 to a network node (e.g., BSS) 122 of the Multi-Operator Core Network of FIG. 1 according to some embodiments. Referring to FIG. 3, the network node (e.g. BSS) 122 determines (block 300) whether an overload condition is occurring and, if so, communicates (block 302) an IR indication within one or more Access Grant Channel (AGCH) messages or Paging Channel (PCH) messages to MSs 100 served by the network node 122. The IR indication identifies that an IR feature is active to restrict access attempts to the network node 122.

The network node 122 may determine that an overload condition exists based on present loading (e.g., less than a threshold availability of communication resources, more than a threshold rate of MS access attempts, etc.) of the network node 122, based on a message received from one or more MMEs 150, one or more SGSNs 140, or other network non-shared nodes 180 that indicates that an overload condition exists, and/or based on one or more 3GPP processes for determining when an overload condition exists that should cause an IR feature to be active and an IR indication to be communicated to MSs 100 to restrict access attempts by the MSs 100.

In some embodiments, the IR indication is communicated (block 302) within a variable percentage of the AGCH messages or PCH messages to the MSs 100. The term “variable percentage” means that the network node 122 (BSS) will indicate that IR is enabled within one or more of the AGCH/PCH messages its sends during any given time interval (note that each individual AGCH/PCH message is capable of indicating whether or not an IR condition exists). The selected percentage of AGCH/PCH messages can indicate the degree to which overloading is being experienced by the network node 122 (BSS) or a non-shared network node (i.e. the greater the degree of overloading the higher percentage of AGCH/PCH messages sent during a given time interval that will indicate that IR is enabled). The specific AGCH/PCH message(s) any given MS 100 reads during an access attempt will be non-deterministic and so the only way for a network node 122 (BSS) to increase the probability of an MS 100 detecting that IR is enabled (while attempting system access) is to increase the percentage of the AGCH/PCH messages that provide this indication (e.g. if 100% of AGCH/PCH messages indicate IR is enabled then there is a 100% chance that an accessing MS 100 will detect it). So “variable percentage” allows from 0% to 100% of AGCH/PCH messages sent during any given time interval to indicate that IR is enabled.

The MS 100 may determine if the IR feature is active prior to and/or after communicating one of more channel request messages to the network node only if it is configured for Low Access Priority (LAP). Thus, for example, after sending a first channel request message for a given access request (note that a given access request may allow a MS to send more than one channel request depending on the feedback it receives in response to any given channel request), the MS 100 can receive (block 304) the AGCH or PCH message from the network node 122. The MS 100 determines (block 308) that the AGCH or PCH message contains an IR indication identifying that an IR feature is active to restrict access attempts to the network node 122.

In some embodiments, the MS 100 determines (block 301) whether it is configured for Low Access Priority (LAP) and, if so, performs the determination (block 308) of whether any received AGCH or PCH message contains the Implicit Reject indication. The MS 100 can perform the determination (block 301) of LAP configuration and responsive determination (block 308) that the AGCH or PCH message contains the Implicit Reject indication, prior to sending a first channel request message within the context of an access request.

Responsive to determining that the IR feature is active, the MS 100 further determines whether the IR feature applies to the registered PLMN of the MS 100. The network node 122 facilitates this further determination by the MS 100, by communicating (block 310) a broadcast message to the MSs 100 it is serving, where the broadcast message contains identifying at least one of the PLMNs to which the IR feature applies.

The MS 100 correspondingly receives (block 312) the broadcast message, and determines (block 314) that the broadcast message contains information identifying at least one of the PLMNs to which the Implicit Reject feature applies. The MS 100 further determines (block 316) whether the registered PLMN of the MS 100 matches at least one of the PLMNs identified by the information contained in the broadcast message (312) and, if so, restricts (block 318) access attempts to the network node 122.

Accordingly, in the embodiment where the MS determines (block 301) whether it is configured for LAP, the operations to determine (block 308) that the AGCH or PCH message contains an Implicit Reject indication are performed in response to the MS 100 being configured for LAP.

In some embodiments, the network node 122 communicates (block 310) the information identifying at least one of the PLMNs to which the IR feature applies, in system information of a BCCH. In a further embodiment, the information identifying at least one of the PLMNs to which the IR feature applies is communicated (block 310) in the system information 22 (SI22) message using BCCH Extended, such as illustrated in FIG. 2. In still a further embodiment, the information identifying at least one of the PLMNs to which the IR feature applies is encoded (210 of FIG. 2) in 5 bits of the system information 22 (SI22) message using BCCH Extended. In still a further embodiment, the information identifying at least one of the PLMNs to which the IR feature applies is communicated (block 310) in a block of four Time Division Multiple Access (TDMA) frames (210 of FIG. 2) of a 51-multiframe BCCH occurring once within a defined number of consecutive 51-multiframes. The defined number may by every fourth Transmission Condition (TC) of a 51-multiframe BCCH Extended.

The MS 100 can operate according to a corresponding set of embodiments. The information identifying at least one of the PLMNs to which the IR feature applies is determined (block 314) by the MS 100 from system information of a BCCH message. In a further embodiment, the information is contained in a system information 22 (SI22) message of BCCH Extended. In a further embodiment, the information is contained in 5 bits (210 of FIG. 2) in the system information 22 (SI22) message. In still a further embodiment, the information is determined (block 314) from a block of four TDMA frames (210 of FIG. 2) of a 51-multiframe BCCH occurring once within a defined number of consecutive 51-multiframes. The defined number may by every fourth Transmission Condition (TC) of a 51-multiframe BCCH Extended.

### Example Network Node and Mobile Station

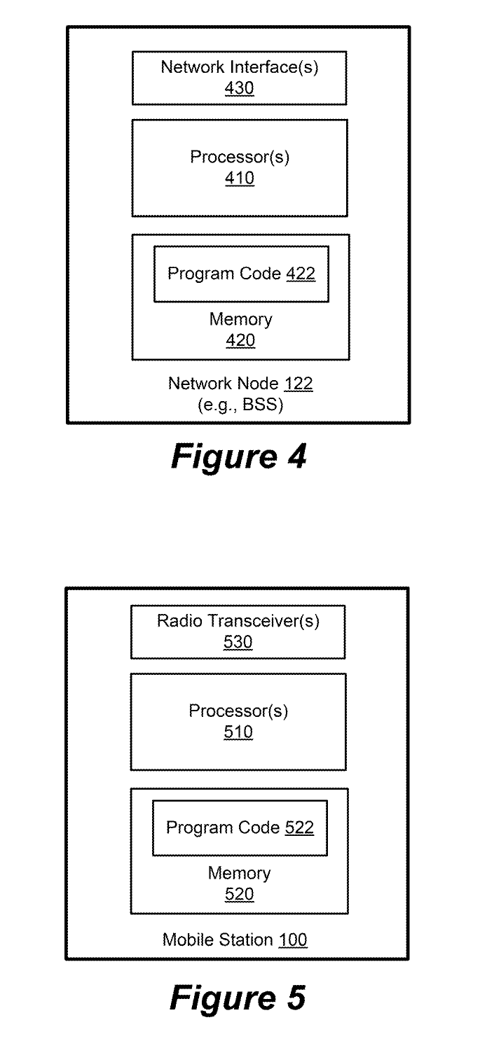

FIG. 4 is a block diagram of a network node 122 (e.g., BSS) that is configured according to some embodiments. The network node 122 may be used as one or more of the elements of FIGS. 1 and 3, including, but not limited, to the BSS 122, a network node of the UTRAN 110, and a network node of the E-UTRAN 130. The network node 122 can include one or more network interfaces 430, one or more processors 410, and one or more memories 420 containing program code 422.

The processor 410 may include one or more data processing circuits, such as a general purpose and/or special purpose processor (e.g., microprocessor and/or digital signal processor) that may be collocated or distributed across one or more networks. The processor 410 is configured to execute program code 422 in the memory 420, described below as a computer readable medium, to perform some or all of the operations and methods that are described above for one or more of the embodiments, such as the embodiments of FIGS. 1-3. Accordingly, the processor 410 can be configured by execution of the program code 422 to carry out at least some of the functionality disclosed herein to control access attempts by MSs to the network node 122. The network node 122 can support a MOCN having a plurality of PLMNs.

FIG. 5 is a block diagram of a MS 100 that is configured according to some embodiments. The MS 100 may be used as the MS 100 of FIGS. 1-3. The MS 100 can include one or more radio transceivers 530, one or more processors 510, and one or more memories 520 containing program code 522.

The processor 510 may include one or more data processing circuits, such as a general purpose and/or special purpose processor (e.g., microprocessor and/or digital signal processor) that may be collocated or distributed across one or more networks. The processor 510 is configured to execute program code 522 in the memory 520, described below as a computer readable medium, to perform some or all of the operations and methods that are described above for one or more of the embodiments, such as the embodiments of FIGS. 1-3. Accordingly, the processor 510 can be configured by execution of the program code 522 to carry out at least some of the functionality disclosed herein to control access attempts to a network node supporting a MOCN having a plurality of PLMNs.

### Abbreviations:

A list of abbreviations used in the present disclosure is provided below for ease of reference of the reader:
3GPP Third Generation Partnership Project
AGCH Access Grant Channel
BCCH Broadcast Control Channel
BSC Base Station Controller
BSS Base Station Subsystem
CS Circuit Switched
EAB Extended Access Barring
EDGE Enhanced Data rates for GSM Evolution
E-UTRAN Evolved Universal Terrestrial Radio Access Network
eNodeB E-UTRAN NodeB
FACCH Fast Associated Control Channel
FULL-MOCN FULL-Multi-Operator Core Network
GERAN GSM EDGE Radio Access Network
GPRS General Packet Radio Service
GWCN Gateway Core Network
IE Information Element
IMS IP Multimedia Subsystem
IR Implicit Reject
LAP Low Access Priority
MME Mobility Management Entity
MS Mobile Station
MSC Mobile Switching Centre
PCH Paging Channel
PLMN Public Land Mobile Network
PS Packet Switched
RAT Radio Access Technology
RAN Radio Access Network
RNC Radio Network Controller
RNS Radio Network Subsystem
SGSN Serving GPRS Support Node
SGW Serving Gateway
SI System Information
TC Transmission Condition
TDMA Time Division Multiple Access
UMTS Universal Mobile Telecommunications System
UTRAN UMTS Terrestrial Radio Access Network

### Further Definitions and Embodiments

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” and “/” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. A method in a network node for restricting access attempts by a plurality of mobile stations (MSs), the network node supporting a Multi-Operator Core Network (MOCN) having a plurality of Public Land Mobile Networks (PLMNs), the method comprising the steps of:
determining that an overload condition is occurring;
responsive to determining that the overload condition is occurring, communicating an Implicit Reject indication within one or more Access Grant Channel (AGCH) messages or Paging Channel (PCH) messages to the MSs identifying that an Implicit Reject feature is active to restrict access attempts to the network node; and
communicating a broadcast message to the MSs containing information identifying at least one of the PLMNs to which the Implicit Reject feature applies, whereby any of the MSs registered with the at least one of the PLMNs identified by the information can restrict their access attempts to the network node.

2. The method of claim 1, wherein:
the information identifying at least one of the PLMNs to which the Implicit Reject feature applies is communicated in system information message of a Broadcast Control Channel.

3. The method of claim 2, wherein:
the information identifying at least one of the PLMNs to which the Implicit Reject feature applies is communicated in a system information 22 (SI22) message of Broadcast Control Channel Extended.

4. The method of claim 3, wherein:
the information identifying at least one of the PLMNs to which the Implicit Reject feature applies is encoded in 5 bits of the system information 22 (SI22) message of the Broadcast Control Channel Extended.

5. The method of claim 2, wherein:
the information identifying at least one of the PLMNs to which the Implicit Reject feature applies is communicated in a block of four Time Division Multiple Access (TDMA) frames of a 51-multiframe sent on a Broadcast Control Channel and occurring once within a defined number of consecutive 51-multiframes.

6. The method of claim 2, wherein:
the information identifying at least one of the PLMNs to which the Implicit Reject feature applies is communicated in a block of four Time Division Multiple Access (TDMA) frames occurring every fourth Transmission Condition (TC) of a 51-multiframe sent using Broadcast Control Channel Extended.

7. A method in a mobile station (MS) for restricting access attempts to a network node supporting a Multi-Operator Core Network (MOCN) having a plurality of Public Land Mobile Networks (PLMNs), the method comprising the steps of:
receiving an Access Grant Channel (AGCH) or Paging Channel (PCH) message from the network node;
determining that the AGCH or PCH message contains an Implicit Reject indication identifying that an Implicit Reject feature is active to restrict access attempts to the network node; and
receiving a broadcast message from the network node;
determining that the broadcast message contains information identifying at least one of the PLMNs to which the Implicit Reject feature applies;
determining that the registered PLMN of the MS matches at least one of the PLMNs identified by the information contained in the broadcast message; and
restricting access attempts to the network node in response to the determination that the registered PLMN of the MS matches at least one of the PLMNs identified by the information contained in the broadcast message.

8. The method of claim 7,
further comprising determining that the MS is configured for low access priority; and
wherein the determining that the AGCH or PCH message contains an Implicit Reject indication is performed in response to the MS being configured for low access priority.

9. The method of claim 7, wherein:
the information identifying at least one of the PLMNs to which the Implicit Reject feature applies is contained in system information message of a Broadcast Control Channel.

10. The method of claim 7, wherein:
the information identifying at least one of the PLMNs to which the Implicit Reject feature applies is contained in a system information 22 (SI22) message sent using Broadcast Control Channel Extended.

11. The method of claim 10, wherein:
the information identifying at least one of the PLMNs to which the Implicit Reject feature applies is contained in 5 bits of the system information 22 (SI22) message.

12. The method of claim 9, wherein:
the information identifying at least one of the PLMNs to which the Implicit Reject feature applies is determined from a block of four Time Division Multiple Access (TDMA) frames of a 51-multiframe sent on a Broadcast Control Channel and occurring once within a defined number of consecutive 51-multiframes.

13. The method of claim 9, wherein:
the information identifying at least one of the PLMNs to which the Implicit Reject feature applies is determined from a block of four Time Division Multiple Access (TDMA) frames occurring every fourth Transmission Condition (TC) of the 51-multiframes sent using Broadcast Control Channel Extended.

14. A network node that restricts access attempts by a plurality of mobile stations (MSs), the network node supporting a Multi-Operator Core Network (MOCN) having a plurality of Public Land Mobile Networks (PLMNs), the network node comprising:
at least one processor; and
at least one memory coupled to the at least one processor and comprising computer readable program code that when executed by the at least one processor causes the at least one processor to perform operations comprising:
determining that an overload condition is occurring; and
responsive to determining that the overload condition is occurring, communicating an Implicit Reject indication within one or more Access Grant Channel (AGCH) messages or Paging Channel (PCH) messages to the MSs identifying that an Implicit Reject feature is active to restrict access attempts to the network node; and
communicating a broadcast message to the MSs containing information identifying at least one of the PLMNs to which the Implicit Reject feature applies, whereby any of the MSs registered with the at least one of the PLMNs identified by the information can restrict their access attempts to the network node.

15. The network node of claim 14, wherein:
the information identifying at least one of the PLMNs to which the Implicit Reject feature applies is communicated in system information message of a Broadcast Control Channel.

16. The network node of claim 15, wherein:
the information identifying at least one of the PLMNs to which the Implicit Reject feature applies is communicated in a system information 22 (SI22) message using Broadcast Control Channel Extended.

17. The network node of claim 16, wherein:
the information identifying at least one of the PLMNs to which the Implicit Reject feature applies is encoded in 5 bits of the system information 22 (SI22) message of Broadcast Control Channel Extended.

18. The network node of claim 15, wherein:
the information identifying at least one of the PLMNs to which the Implicit Reject feature applies is communicated in a block of four Time Division Multiple Access (TDMA) frames of a 51-multiframe sent on a Broadcast Control Channel and occurring once within a defined number of consecutive 51-multiframes.

19. The network node of claim 15, wherein:
the information identifying at least one of the PLMNs to which the Implicit Reject feature applies is communicated in a block of four Time Division Multiple Access (TDMA) frames occurring every fourth Transmission Condition (TC) of the 51-multiframes sent using Broadcast Control Channel Extended.

20. A mobile station (MS) that accesses a network node supporting a Multi-Operator Core Network (MOCN) having a plurality of Public Land Mobile Networks (PLMNs), the MS comprising:
at least one processor; and
at least one memory coupled to the at least one processor and comprising computer readable program code that when executed by the at least one processor causes the at least one processor to perform operations comprising:
receiving an Access Grant Channel (AGCH) or Paging Channel (PCH) message from the network node;
determining that the AGCH or PCH message contains an Implicit Reject indication identifying that an Implicit Reject feature is active to restrict access attempts to the network node; and
receiving a broadcast message from the network node;
determining that the broadcast message contains information identifying at least one of the PLMNs to which the Implicit Reject feature applies;
determining that the registered PLMN of the MS matches at least one of the PLMNs identified by the information contained in the broadcast message; and
restricting access attempts to the network node in response to the determination that the registered PLMN of the MS matches at least one of the PLMNs identified by the information contained in the broadcast message.

21. The MS of claim 20, further comprising:
computer readable program code that when executed by the at least one processor causes the at least one processor to perform operations further comprising determining that the MS is configured for low access priority,
wherein the determining that the AGCH or PCH message contains an Implicit Reject indication is performed in response to the MS being configured for low access priority.

22. The MS of claim 20, wherein:
the information identifying at least one of the PLMNs to which the Implicit Reject feature applies is contained in a system information message of a Broadcast Control Channel.

23. The MS of claim 22, wherein:
the information identifying at least one of the PLMNs to which the Implicit Reject feature applies is contained in a system information 22 (SI22) message of Broadcast Control Channel Extended.

24. The MS of claim 23, wherein:
the information identifying at least one of the PLMNs to which the Implicit Reject feature applies is contained in 5 bits of the system information 22 (SI22) message.

25. The MS of claim 22, wherein:
the information identifying at least one of the PLMNs to which the Implicit Reject feature applies is determined from a block of four Time Division Multiple Access (TDMA) frames of a 51-multiframe sent on a Broadcast Control Channel and occurring once within a defined number of consecutive 51-multiframes.

26. The MS of claim 22, wherein:
the information identifying at least one of the PLMNs to which the Implicit Reject feature applies is determined from a block of four Time Division Multiple Access (TDMA) frames occurring every fourth Transmission Condition (TC) of the 51-multiframes sent using Broadcast Control Channel Extended.
